(19) United States
(12) Patent Application Publication
(10) Pub. No.: US 2026/0072704 A1
(43) Pub. Date: Mar. 12, 2026

(54) METHOD AND SYSTEM TO AUTO-CONNECT DATA-DRIVEN APPLICATIONS WITH SUITABLE DATA SOURCES

(71) Applicant: NEC Laboratories Europe GmbH, Heidelberg (DE)

(72) Inventors: Tobias JACOBS, Heidelberg (DE); Gürkan SOLMAZ, Heidelberg (DE)

(21) Appl. No.: 19/106,646

(22) PCT Filed: Jul. 11, 2023
(86) PCT No.: PCT/EP2023/069238

§ 371 Date: Feb. 26, 2025

(30) Foreign Application Priority Data
Mar. 2, 2023 (EP) 23159767

(51) Int. Cl. G06F 9/445

(52) U.S. Cl. CPC G06F 9/44521

(57) ABSTRACT

A computer-implemented method auto-connects a data-driven application with one or more suitable data sources. The method includes identifying, by a context region explorer based on a description of the application, a context region of a context graph that represents a context of the application; requesting, by the context region explorer, data related to the identified context region from a context enrichment platform connected to a number of data sources; and receiving, by the context region explorer, the requested data from the context enrichment platform and making the received requested data available to the application.

### CROSS REFERENCE TO RELATED APPLICATIONS

This application is a U.S. National Phase application under 35 U.S.C. § 371 of International Application No. PCT/EP2023/069238, filed on Jul. 11, 2023, and claims benefit to European Patent Application No. 23159767.5, filed on Mar. 2, 2023. The International Application was published in English on Sep. 6, 2024 as WO 2024/179693 A1 under PCT Article 21(2).

### FIELD

The present invention relates to a method and system to auto-connect data-driven applications with one or more suitable data sources.

### BACKGROUND

Data is the key driver of more and more digital applications across a plethora of different domains. The last decade has witnessed the development of technology to increasingly automate the data processing chains. For instance, optimizing the parameters of powerful prediction and classification models often happens fully automatically (for reference, see L. Zahedi, et al.: “Search algorithms for automated hyper-parameter tuning”, arXiv preprint arXiv: 2104.14677, 2021). Moreover, the task of selecting and configuring the most suitable pipeline of preprocessing methods, machine learning models, and training algorithms has been successfully automatized (for reference, see R. S. Olson, and J. H. Moore: “TPOT: A tree-based pipeline optimization tool for automating machine learning”, Workshop on automatic machine learning, JMLR, 2016).

In the prior art, automated feature selection methods have been described, e.g. in A. Kaul, S. Maheshwary, and V. Pudi: “Autolearn-Automated feature generation and selection” in IEEE International Conference on data mining (ICDM), 2017, but such methods do not scale beyond a few dozens of data sources and are not applicable in situations with thousands or more data sources, because (a) the computational effort required to evaluate every possible combination of data sources as input is beyond feasibility, and (b) often manual effort is required to pre-select potential sources.

### SUMMARY

In an embodiment, the present disclosure provides a computer-implemented method to auto-connect a data-driven application with one or more suitable data sources. The method includes identifying, by a context region explorer based on a description of the application, a context region of a context graph that represents a context of the application; requesting, by the context region explorer, data related to the identified context region from a context enrichment platform connected to a number of data sources; and receiving, by the context region explorer, the requested data from the context enrichment platform and making the received requested data available to the application.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view illustrating the basic architecture and control flow of a system according to an example embodiment of the present disclosure; and

FIG. 2 is a schematic view illustrating a QoS-and context-based feedback and optimization mechanism of a context-region explorer according to an example embodiment of the present disclosure.

### DETAILED DESCRIPTION

Given the shortcomings of the prior art discussed above, embodiments of the present disclosure provide an improved concept for auto-connecting data-driven applications with one or more suitable data sources. In particular, embodiments of the present disclosure can address issues of automatically identifying suitable data for a given data-driven application. Provided a description of the application and the environment(s) where it will be applied, embodiments of the present disclosure can provide methods and systems that automatically connect the application to the most suitable data sources.

In an embodiment, the present disclosure provides a computer-implemented method to auto-connect data-driven applications with one or more suitable data sources. The method comprises identifying, by a context region explorer based on a description of the application, a context region of a context graph that represents a context of the application. The context region explorer requests data related to the identified context region from a context enrichment platform connected to a number of data sources. The context region explorer receives the requested data from the context enrichment platform and makes the received data available to the application.

According to further embodiments, the present disclosure provides a corresponding system to auto-connect data-driven applications with one or more suitable data sources and a tangible, non-transitory computer-readable medium, as specified in the independent claims.

In an embodiment, the present disclosure provides an approach that enriches and systematically exploits available context information by scanning a contextual region of the application for related data. To this end, an application may send a description of itself to the context region explorer. The context region explorer computes from the application description, a region of the context graph that represents the context of the application. The context region explorer requests data related to the identified context region from the context enrichment platform. Then, the context enrichment platform sends the requested data to the context region explorer, and the context region explorer makes the received data available to the application.

Embodiments of the present disclosure provide the advantage of a substantial reduction of a data preprocessing and feature selection effort of data scientists, including reduced rental, purchase, and energy costs of computational equipment (GPUs, Cloud computing). Furthermore, embodiments of the present disclosure allow for an easy deployment of new data-driven applications, as well as for an improved adaptiveness and robustness of data-driven applications to changes in the long-term deployments; maintaining a higher QoS for a longer time.

According to an embodiment, the context graph may be generated by the context enrichment platform based on data received from connected data sources. Generating the context graph may include the step of extracting a schema of the data of each of the connected data sources, wherein the schema may include information about the structure and/or vocabulary used by the respective data source. The concepts that appear in the extracted schemas may be mapped to the concepts of an existing backbone ontology.

Alternatively and/or additionally, the context graph may be generated by extracting from the data of each of the connected data sources real-world and/or digital entities related to the respective data sources, and by mapping each unit of data to the real-world and/or digital entity it relates to. Relations between the real-world and/or digital entities may be determined based on properties of the related data. In the context graph, the real-world and/or digital entities constitute the nodes of the context graph, while the relations between the real-world and/or digital entities constitute the edges between the nodes.

According to an embodiment, it may be provided that the context graph is enriched by additional context information computed by the context enrichment platform for the connected data sources. The additional context information may be derived from interrelations among the data sources and/or from relations of the data sources with other real-world and/or digital objects.

With respect to an optimized resource usage of the context enrichment platform, it may be provided that the context graph enrichment by additional context information computed by the context enrichment platform is limited to the identified context regions of the context graph that represent a respective context of the applications. In this context, it may be provided that the context region explorer guide the resource usage optimization of the context-enrichment platform by providing “demands” to the platform such that the platform can operate in an on-demand way. This approach can avoid that the context enrichment platform enriches possibly irrelevant data sources.

According to an embodiment, it may be provided that the context region explorer, based on the description of an application, identifies a context region of a context graph that represents a context of the application by first determining a central node of the context graph that matches with the description of the application. Based thereon, the context region explorer may then determine the context region as a subgraph of the context graph in such a way that the subgraph contains those nodes of the context graph that are close to the central node or, more precisely, that have a graph distance to the central node that is shorter than a predefined or configurable threshold.

According to an embodiment, it may be provided that the identified context region of the context graph that represents a context of the application is monitored, either on a continuous or on a periodic basis, and that the identified context region is adapted to the requirements of the application and/or the availability of the connected data sources. In order to enable the context region explorer to become aware of the application's requirements, a dedicated context region API may be implemented between the application the context region explorer, wherein the context region API may be used by the application to expose its internal service and/or resource usage limitations towards the context region explorer.

With respect to a further enhanced benefit for the applications using the systems, it may be provided that the context region explorer-continuously or periodically-adapts the identified context region of the context graph that represents a context of a respective application based on feedback provided by this application. According to an embodiment, the feedback provided by the application may comprise QoS related and/or context related feedback. For instance, the QoS related feedback may include information on a current and a target accuracy of the application, information on the energy consumption of the application's computation, and/or further QoS related information. On the other hand, according to embodiments, the context related feedback may include information on the relevance of connected data sources, information on the relevance of individual data features of connected data sources, information on a relative sparsity, noise and/or other characteristics of data features of connected data sources, information on data source-specific costs, and/or further context related information.

According to an embodiment, embodiments may be applied in the technical field of building management. In such scenario, the data-driven application may include an application control for controlling a HVAC (Heating, Ventilation and Air Conditioning) system of a building, and the connected data sources may include at least one of a number of cameras, air quality sensors, indoor and outdoor temperature sensors, window status sensors, and light switch status sensors. The HVAC system may be automatically operated, e.g., based on predictions of the occupancy of each room, as well as predictions of the outdoor temperature and the window-opening habits of occupants. This application may require data to be feed as input to several prediction models, both historical data for model training and real-time data for decision making. The available data sources are connected to the context enrichment platform. One instance of the HVAC control system may be set up for each controllable section of the system (e.g. per room, or per floor). Each instance may act as an application towards the context region explorer to obtain the set of data sources required to feed its prediction models. Based on the data flowing through the system from the sensors to the applications in accordance with the embodiments of the present disclosure, the HVAC system is enabled to effectively control the heating and cooling of the building.

According to another embodiment, embodiments may be applied in the technical field of carbon emission monitoring. In such scenario, the data-driven application may include an application that computes carbon emissions on a high-granularity in a building or in a smart city (as described in https://oascities.org/wp-content/uploads/2022/02/Ernoe-Kovacs_CxC22 Get-Practical-with-NEC.pdf, which is hereby incorporated herein by reference). This application may require crowdsourced mobility data (e.g., NREL OpenPath) as well as appropriate sensors in the building/city. As such, the connected data sources may include at least one of cameras, air quality sensors, indoor/outdoor temperatures, traffic sensors, magnetic loop sensors, crowd behaviors from smartphone sensors, and/or bicycle counters. All available data sources are connected to the context enrichment platform. The insights from the CO2 computation may be listed in the city dashboard as well as used for notifying individuals for their CO2 emissions (e.g., smartphone notifications). Each city/building CO2 monitoring and personalized CO2 emission monitoring are the applications that may be required to be fed by the context region explorer. Based on the data flowing through the system from the sensors to the CO2 monitoring applications in accordance with the embodiments of the present disclosure, the CO2 monitoring applications are enabled to effectively measure and compute properties of the physical world (environmental parameters).

According to another embodiment, the embodiments may be applied in the technical field of manufacturing. Manufacturing generally requires efficiency in a smart factory environment, in which humans and robots interact with each other to provide high quality production in the safest way. Furthermore, one smart factory can be connected to another such that certain efficient behaviors learned in one factory can be applied in another factory.

In such scenario, the data-driven application may include a (task) planning application that is designed to make decisions of placement of certain equipment and assignment of robots and people in certain tasks. Different task plans would lead to different outcomes (e.g., time and cost of production). Each factory would have an application that decides on the task planning AI agent for the set of tasks that needs to be conducted to produce an item. Context region explorer can provide suitable data sources to the AI agent to be used in its task planning algorithm.

Based on the data flowing through the system from the sensors to the applications in accordance with the embodiments of the present disclosure, the planning application is enabled to dynamically change task plans for human and robot assignments, meeting production objectives.

According to another embodiment, the embodiments may be applied in the technical field of traffic management. In such scenario, the data-driven application may include a traffic application that considers routing behavior autonomous driving. The traffic application may be designed to route a vehicle on the best possible path which consists of a finite set of trajectory points. The planned trajectories can be updated in real time based on measurements in the large regional environments (e.g., campus, city, intercity). As such, the connected data sources may include at least one of cameras, road-side sensors, GPS sensors, and/or vehicular sensors such as LiDAR. All available data sources are connected to the context enrichment platform.

Based on the data received from the context region explorer in accordance with the embodiments of the present disclosure, each autonomous vehicle may decide in real-time and update its trajectory planning for the routing inside the region of interest. For instance, each vehicle can update its path based on an unexpected traffic event or existence of many vulnerable road users, potholes, or other obstacles in the area.

Based on the data flowing through the system from the sensors to the applications in accordance with the embodiments of the present disclosure, a traffic application in road vehicles may effectively change the vehicle's routes (i.e. the paths of the vehicle), thereby causing less traffic due to optimal routing decisions.

According to another embodiment, the embodiments of the present disclosure may be applied in the technical field of green computing. For instance, in a distributed computing environment with cloud and edge devices as well as network equipment, performance indicators like battery health, power consumption, and computational resources (CPU, GPU, memory, bandwidth) are monitored and recorded over time. The resulting time series are connected by the graph that represents the network topology, and predictions of future indicator values are taken into account for automated assignment of computational tasks to devices. In this context, the data-driven application may include a task scheduling application and the connected data sources may include distributed sensors and equipment for measuring the above mentioned performance indicators. Based on the data flowing through the system from the sensors to the data-driven application in accordance with the embodiments of the present disclosure, the application is enabled to effectively perform task scheduling such that the energy consumption of devices is reduced and the battery lifetime of edge devices is improved.

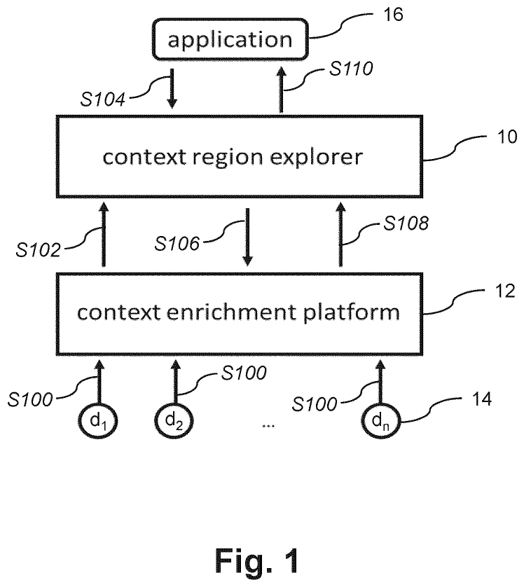

FIG. 1 schematically illustrates the system architecture of a system for auto-connecting data-driven applications with suitable data sources according to an example embodiment of the present disclosure. Specifically, according to the illustrated embodiment, the system comprises a context region explorer 10 and a context enrichment platform 12. It is noted that context enrichment platforms do exist already, but in prior art deployments the context data nowadays is explored by hand for identifying suitable data. As such, applications need to be programmed by hand to connect to the right data sources available in the system. To overcome these shortcomings, the embodiments of the present disclosure can introduce a novel component, namely the context region explorer 10, whose structure and mode of operation are described in detail below.

According to an embodiment, the workflow of the system with the new context region explorer 10 comprises the following steps:

In a setup phase of the system, it may be provided that connected data sources 14, denoted d₁, . . . , dₙ in FIG. 1, send data to the context enrichment platform 12, as shown at steps S100. For live data sources, data may be continuously updated.

In an embodiment, the context enrichment platform 12 may be configured to compute additional context information (in the present disclosure, no distinction is made between metadata and context information) for each data source 14, including relations to other data sources 14 and/or other real-world and/or digital objects. This information may be saved in a context graph G where the data sources and real-world objects appear as nodes.

The setup phase may be terminated by the context graph G being sent to the context region explorer 10, as illustrated at step S102 in FIG. 1.

Next, as shown at step S104, an application 16 that wishes to use the system sends a description A of itself (including a targeted environment of the application 16) to the context region explorer 10.

The context region explorer 10 may be configured to compute, from the application description A, a context region R⊂G of the context graph G that represents the context of the application 16. A context region may be a subgraph containing the nodes having a short graph distance to a central node of the context graph G that represents the application context.

Based thereupon and as illustrated at step S106, the context region explorer 10 may request, from the context enrichment platform 12, data X_{d}, d ∈ R from one or more of the data sources d in the identified context region R of the context graph G. As shown at step S108, the context enrichment platform 12 may send the requested data X_{d}, d ∈ R to the context region explorer 10. Next, the context region explorer 10 makes the received data X_{d}, d ∈ R available to the application 16, as shown at step S110.

According to an embodiment, the generation of the context graph G in the setup phase may be realized by extracting, from each of the data sources 14, a schema of the data, wherein the schema may contain information about, e.g., the structure and vocabulary used by each data source 14. The concepts that appear in the schemas are mapped to the concepts of an existing backbone ontology, wherein real-world and/or digital entities related to the data sources 14 are extracted and each unit of data is mapped to the real-world and/or digital entity it relates to. Relations between the entities may be determined based on properties of the associated data (e.g., geographic co-location, correlations of data, etc.).

Each of the steps described above can be executed fully automatically by respective data processing algorithms. Alternatively, as the case may be, one or more of the steps may be executed with the help of a human expert in an interactive manner.

According to an embodiment, the context region R⊂G for a particular application 16 may be determined by associating the application 16, based on a description of the application 16 (which, e.g., may have supplied to the context region explorer 10 by the application 16 itself) with one or more nodes in the context graph G that represent the geographical and/or logical place of the application 16 in the context graph G. In the context of the present disclosure, these nodes are sometimes referred to as “central” nodes. The geographical and/or logical place of the application 16 in the context graph G may be determined, e.g., in terms of the application's 16 monitoring or actuation reach.

Based thereupon, a graph neighborhood around the application 16, i.e. around the one or more central nodes of the context graph G determined as described above, is selected. This graph neighborhood contains those nodes of the context graph G that can be reached in from the application's 16 central node(s) within a (predefined or configurable) maximum number of edge traversals. The context region thus determined is used to identify, within a pool of available data sources 14, suitable data sources 14 for the application 16. For instance, the context of the application 16 could be a room in a building, while the context region could represent, e.g., the devices installed in the respective room as well in neighboring rooms in the same building.

The context graph G neighborhood exploration can be implemented by various potential algorithms for graph traversal to find the best subgraph R⊂G for the application 16. The choice of the algorithm might affect the performance of the context region explorer 10 (e.g., in terms of computation time) and, consequently, also the performance of the application 16. Potential algorithms to implement the graph neighborhood exploration can be greedy algorithms, such as algorithms that explore the vertices in the graph in a breadth-first or depth-first fashion, or more complex machine learning algorithms such as Q learning (e.g., A* path finding). The search space for finding the best set of nodes in the neighborhood of a graph node that has been identified as central node can be large, considering the potential complexity of the context graph G, the NP-hard nature of the problem, as well as various optimizations. The computation time of the optimization can be reduced by existing state-of-art techniques.

While it is noted that the context graph G neighborhood exploration could be realized using different algorithms, an example algorithm is described herein based on the following pseudocode. The example algorithm sets a maximum depth and implements the search with a maximum depth in a breadth-first fashion, applying breadth-first search (BFS) with a maximum depth parameter:

---Pseudocode---
Algorithm 1: Context-region scanning
Input:

| | |
|---|---|
| - | G: (V, E): context graph with set of vertices V and edges E |
| - | vᵢ: initial vertex i representing the target node (to start exploration) |
| - | d: max depth allowed by the Context Region Explorer |

Output:

| | |
|---|---|
| - | V’ ← set of vertices in the context neighborhood |

| | |
|---|---|
| V^{v} ← Ø | # Empty set to represent visited vertices |
| Q ← Ø | # Empty queue to represent vertices for graph exploration |

Enqueue vᵢ to Q

| | |
|---|---|
| V^{v} ← V^{v} ∪ {vᵢ} | # Add vertex to the set of visited vertices |
| V’ ← V’ ∪ {vᵢ} | # Add vertex to the context neighborhood |

While length(Q) > 0:

| | | |
|---|---|---|
| - | vₗ ← Dequeue Q | # Remove and return the last element added to Q |
| - | V^{a} ← Adjacent(vₗ ) | # Set of vertices adjacent to vₗ |

| | |
|---|---|
| - | For each vertex vₙ e from V^{a}: |

| | |
|---|---|
| ∘ | if vₙ ϵ V^{v} |

| | |
|---|---|
| ▪ | Continue |

| ∘ | V^{v} ← V^{v} ∪ {vᵢ} | |
|---|---|---|
| ∘ | eval ← Evaluate(vₙ) | # Evaluate and decide vₙ for its use in the context |

| | |
|---|---|
| | neighborhood |
| ∘ | If eval == Positive: |

| | |
|---|---|
| ▪ | V’ ← V’ U {vₙ} |
| ▪ | If distance(vₙ, vᵢ) < d: # The new vertex vₙ did not reach the max depth |

| | |
|---|---|
| • | Enqueue vₙ to Q |

| | |
|---|---|
| ▪ | Endif |

| | |
|---|---|
| ∘ | Endif |

| | |
|---|---|
| - | Endfor |

Endwhile
Return V’
---End pseudocode---

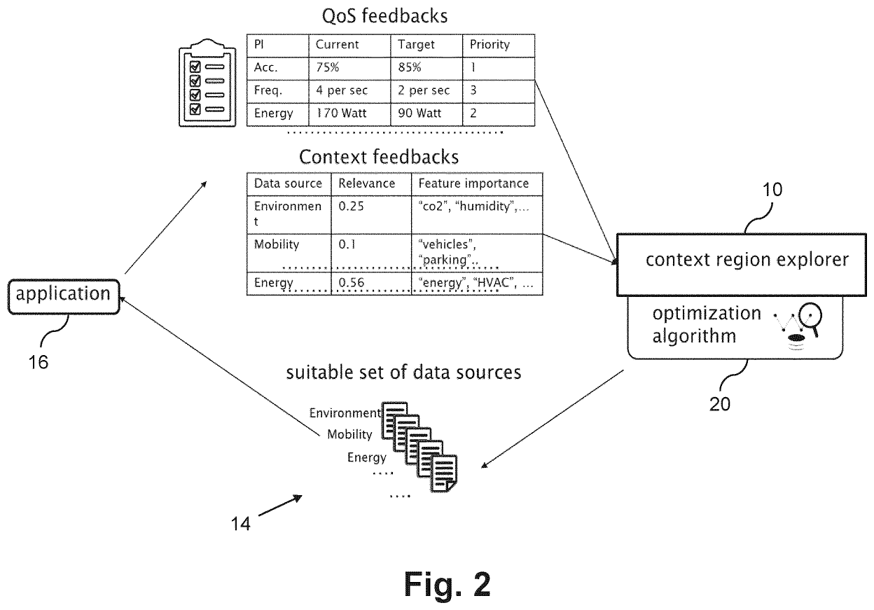

FIG. 2, in which like numerals denote like or similar components as in FIG. 1, schematically illustrates a feedback and optimization mechanism of a context-region explorer 10 according to an example embodiment of the present disclosure. According to the illustrated embodiment, the mechanism, which enables the context region explorer 10 to learn from application 16 feedback, is configured enable QoS-and context-based optimizations.

As shown in FIG. 2, the feedback and optimization mechanism may be implemented as an extension to the context region explorer 10. More specifically, the feedback and optimization mechanism may include a component that scans the connected and contextually enriched data sources 14 (i.e., data sources 14 with additional context information). The context region explorer 10 implements an optimization algorithm 20 that takes the feedback from application 16 into account. To this end, the context region explorer 10 exposes a specific application programming interface (API) towards the data-driven application 16, as illustrated in FIG. 2, called “context-region API”.

The context-region API may be configured to allow to specify feedback and requirements regarding Quality of Service (QoS), such as the current and a target accuracy of the application 16, a frequency of analytics, energy costs of the computation (e.g., 170 Watt), along with priorities of the QoS feedback.

Furthermore, the API may be configured to allow to specify context-related feedbacks, such as information about which data source 14 provides how much value for the data-driven application 16, which can be defined by various metrics. In FIG. 2, the “relevance” metric is considered as a metric of importance of the different data sources 14 for the application 16. Furthermore, for each data source 14, finer-grained metrics can be included (e.g., feature importance, as shown in the third column of the context feedback table shown in FIG. 2). In FIG. 2, for simplicity, the features are listed in the table in order of their importance, whereas each feature can have additional characteristics such as relative and normalized feature importance, feature granularity, sparsity, etc.

Possible items for the QoS feedback include, but are not limited to, the following:
AI performance metrics, including, for instance:
Accuracy, recall, precision, F1-score for the classification task,
Mean squared error (MSE), (normalized) root mean squared error (RMSE) for regression,
Mean absolute error (MAE) for regression, and/or
Rewards and penalties for reinforcement learning applications
Value/insight-related metrics, including, for instance:
Spatiotemporal granularity (frequency, resolution),
Generated number of insights, contribution to objectives, and/or
Generated value (e.g., financial value)
Network-related metrics, including, for instance:
Available bandwidth, expected latency,
Available network slices, and/or
Wireless channel usage
Other metrics, including, for instance:
Energy consumption,
Computational resource usage,
Communication effort, and/or
System scalability, include Cloud/Edge computing resources required.

Possible items for the context feedback include, but are not limited to, the following:
List of relevant data sources 14, wherein a relevance of each data source 14 may be indicated by, e.g., a ranking parameter with values in the range of [0,1]),
List of data features of each data source 14, together with a parameter whose values indicate a relevance/importance of data features,
Relative sparsity, noise and other characteristics of features (for the application side), and/or
Data source-specific costs (e.g., added computing overhead)

The context-region explorer 10 receives the feedback from the data-driven application 16 as described above, and implements an optimization algorithm 20 that takes into account the QoS optimization as well as optimum data source selection in the neighborhood. For instance, the relevant data sources can be given priority in the exploration of the neighborhood in a depth-or breadth-search fashion. Lastly, the context-region explorer 10 provides an adapted set of suitable data source for future use, based on the outputs of its graph search in an optimized way.

The extension for application feedback-based optimization can be implemented through various ways. According to an embodiment of the present disclosure, an implementation may be based on the previous example of the context-neighborhood exploration algorithm as described above. The implementation may add a loss function, in the evaluation step, that takes into account the application feedbacks. Similar to this example, any other possible implementation of the context-neighborhood exploration can be extended by adding a loss function. Lastly, the loss function itself can be implemented through various ways based on the needs of the application 16 and/or context region explorer 10. For instance, certain loss functions may lead to higher complexity in the context region exploration.

An exemplary algorithm for context-region explorer learning from application feedback can be realized based on the following pseudocode:

---Pseudocode---
Algorithm 2: Context-region explorer learning from application feedback
Input:

| | |
|---|---|
| - | G: (V, E): context graph with set of vertices V and edges E |
| - | vᵢ: initial vertex i representing the target node (to start exploration) |
| - | d: max depth allowed by the Context Region Explorer |

Output:

| | |
|---|---|
| - | V’ ← set of vertices in the context neighborhood |

| | |
|---|---|
| V^{v} ← Ø | # Empty set to represent visited vertices |
| Q ← Ø | # Empty queue to represent vertices for graph exploration |

Enqueue vᵢ to Q

| | |
|---|---|
| V^{v} ← V^{v} ∪ {vᵢ} | # Add vertex to the set of visited vertices |
| V’ ← V’ ∪ {vᵢ} | # Add vertex to the context neighborhood |

| | |
|---|---|
| L_{current} = L_{QoS} (V’) + L_{Context}(V’) | # Loss function taking into account QoS and context |

defined by application
While length(Q) > 0:

| | | |
|---|---|---|
| - | vₗ ← Dequeue Q | # Remove and return the last element added to Q |
| - | V^{a} ← Adjacent(vₗ ) | # Set of vertices adjacent to vₗ |

| | |
|---|---|
| - | For each vertex vₙ e from V^{a}: |

| | |
|---|---|
| ∘ | if vₙ ϵ V^{v} |

| | |
|---|---|
| ▪ | Continue |

| ∘ | V^{v} ← V^{v} ∪ {vᵢ} | | |
|---|---|---|---|
| ∘ | L_{new} = L_{QoS} ( V’ ∪ {vₙ})+ L_{Context}( V’ ∪ {vₙ}) | # | Loss |

| | |
|---|---|
| | function taking into account QoS and context |
| ∘ | If L_{new} < L_{current} : |

| ▪ | V’ ← V’ ∪ {vₙ} | |
|---|---|---|
| ▪ | If distance(vₙ, vᵢ) < d: | # The new vertex vₙ did not reach the max |

depth

| | |
|---|---|
| • | Enqueue vₙ to Q |

| ▪ | Endif | |
|---|---|---|
| ▪ | L_{current} ← L_{new} | # Update the loss value with the newly calculated |

loss

| | |
|---|---|
| ∘ | Endif |

| | |
|---|---|
| - | Endfor |

Endwhiledeep q
Return V’
---End pseudocode--

According to embodiments, the identified context region of the context graph that represents a context of the application may be monitored, and the identified context region may be adapted to the requirements of the application and/or the availability of the connected data sources. Specifically, the above process described for the context-region monitoring can be iteratively conducted to adapt to the changes in the following:
1) QoS requirements of the data-driven application; and
2) Context relevance based on changing dynamic characteristics of any given task or environment.

For instance, a particular data source may be relevant for a while, while it may lose its relevance to the task in the long-term as other data sources become available. Furthermore, certain data sources may become unavailable in the long term, due to various reasons such as removing sensors from an environment or energy depletion. Similarly, some sensors may start failing as they get older and produce unreliable data. Lastly, some data sources can become malicious in time due to certain cyber-attacks. The trustability of the data sources can be also considered in the context of “availability” for the data-driven application. Consequently, according to an embodiment, the context-region monitoring is continuously adapting to the requirements of the applications as well as the availability of the data sources.

According to embodiments, an extension of the proposed system may consider an optimized resource usage for the application as well as the context-enrichment platform. Data-driven applications (e.g., vertical applications) are mostly limited in their admissible resource usage due to cost and energy consumption. Thus, they can define their service limitations in the context region API and leverage the suitable data sources based on their internal requirements.

The resources of the context-enrichment platform are potentially limited as well, as the platform needs to satisfy the requirements of many applications. The requirements include enrichment/contextualization of all data sources.

To address these issues, the context region explorer may be configured to guide the resource usage optimization of the context-enrichment platform such that it can provide “demands” to the platform such that the platform can operate in an on-demand way instead of exhaustively enriching possibly irrelevant data sources.

The information and functions available for context enrichment can be categorized as follows:
Initial context information containing location data in the form geographic coordinates;
Initial context information containing relations between data sources and between data sources and other entities;
Contextualization functions that take existing context information for a subset of sources as input and compute a new set of relations (context-driven contextualization); and
Contextualization functions which take the data from a subset of sources as input and compute new relations between the data sources (e.g. correlation analysis of time series-data driven contextualization).

According to an embodiment, on-demand context enrichment for a given entity of interest may be computed as follows (Algorithm 3):
1) Constructing a set S of data sources whose geographic location (initial context data) is within a specific distance from the entity of interest;
2) Adding to S all data sources that are related to a data source in S according to the context information. Repeating this step a certain number of times to add further data sources to S.
3) Running all context-driven contextualization functions computing new relations, adding those relations to the data sources in S.
4) Running all data-driven contextualization functions and adding the resulting relations to S.
5) Repeating steps 3 and 4 a fixed number of times, or until no more relations are found.

To summarize, aspects of the present disclosure may include the following:
1) Organizing available data sources in a context graph and scanning the contextual region of an application for potentially useful data sources, using e.g. an algorithm with graph traversal or subgraph search for implementing the scanning of contextual region (e.g., according to Algorithm 1 as disclosed above).
2) Provision of a feedback loop between the application and the context region explorer, supported by a context region API, to enable adaptations to the application's requirements and QoS using, e.g., an algorithm that extends context region exploration with a QoS-and context-based loss function (e.g., Algorithm 2 as disclosed above).
3) Limiting the context enrichment to the contextual regions defined by the needs of the applications, for instance by implementing an on-demand enrichment (e.g., by running Algorithm 3 as disclosed above).

Many modifications and other embodiments of the present disclosure set forth herein will come to mind to the one skilled in the art to which the disclosure pertains having the benefit of the teachings presented in the foregoing description and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the disclosure or invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented method to auto-connect a data-driven application with one or more suitable data sources, the method comprising:
identifying, by a context region explorer based on a description of the application, a context region of a context graph that represents a context of the application;
requesting, by the context region explorer, data related to the identified context region from a context enrichment platform connected to a number of data sources; and
receiving, by the context region explorer, the requested data from the context enrichment platform and making the received requested data available to the application.

2. The method according to claim 1, wherein the context graph is generated by the context enrichment platform based on data received from the connected data sources.

3. The method according to claim 2, wherein generating the context graph comprises:
extracting a schema of the received data of each of the connected data sources, the schema comprising information about the structure and/or vocabulary used by the respective connected data source; and
mapping concepts that appear in the extracted schemas to concepts of an existing backbone ontology.

4. The method according to claim 2, wherein generating the context graph comprises:
extracting from the received data of each of the connected data sources real-world and/or digital entities related to the respective connected data sources;
mapping each unit of the received data to the real-world and/or the digital entity it relates to; and
determining relations between the real-world and/or the digital entities based on properties of the related data.

5. The method according to claim 1, wherein the context graph is enriched by additional context information computed by the context enrichment platform for the connected data sources, wherein the additional context information is derived from interrelations among the connected data sources and/or from relations of the connected data sources with other real-world and/or digital objects.

6. The method according to claim 5, wherein the context graph enrichment by the additional context information computed by the context enrichment platform is limited to the identified context regions of the context graph that represent the respective context of the applications.

7. The method according to claim 1, wherein the step of identifying, by the context region explorer based on the description of the application, the context region of the context graph that represents the context of the application, comprises:
determining a central node of the context graph that matches with the description of the application; and
determining the context region as a subgraph of the context graph, the subgraph containing nodes of the context graph having a graph distance to the central node that is shorter than a predefined threshold.

8. The method according to claim 1, further comprising:
monitoring the identified context region of the context graph that represents the context of the application; and
adapting the identified context region to requirements of the application and/or the availability of connected data sources.

9. The method according to claim 1, wherein the application exposes, via a dedicated context region API, internal service and/or resource usage limitations of the application.

10. The method according to claim 1, wherein the context region explorer adapts the identified context region of the context graph that represents the context of the application based on feedback provided by the application.

11. The method according to claim 10, wherein the feedback provided by the application comprises QoS related feedback, comprising information on a current and a target accuracy of the application, information on the energy consumption of the application's computation, and/or further QoS related information.

12. The method according to claim 10, wherein the feedback provided by the application comprises context related feedback, comprising information on a relevance of connected data sources, information on a relevance of individual data features of the connected data sources, information on a relative sparsity, noise and/or other characteristics of data features of the connected data sources, information on data source-specific costs, and/or further context related information.

13. A system to auto-connect a data-driven application with one or more suitable data sources, the system comprising a context region explorer configured to;
identify, based on a description of the application, a context region of a context graph that represents a context of the application;
request data related to the identified context region from a context enrichment platform connected to a number of data sources; and
receive the requested data from the context enrichment platform and making the received requested data available to the application.

14. The system according to claim 13, wherein the data-driven application comprises an application control for controlling a HVAC system of a building, and wherein the connected data sources include at least one of a number of cameras, air quality sensors, indoor and outdoor temperature sensors, window status sensors, and light switch status sensors.

15. A tangible, non-transitory computer-readable medium having instructions thereon which, upon being executed by one or more processors, alone or in combination, provide for execution of a method to auto-connect a data-driven application with one or more suitable data sources, the method comprising:
identifying, based on a description of the application, a context region of a context graph that represents a context of the application;
requesting data related to the identified context region from a context enrichment platform connected to a number of data sources; and
receiving the requested data from the context enrichment platform and making the received requested data available to the application.
